(19) United States
(12) Patent Application Publication
(10) Pub. No.: US 2015/0223393 A1
(43) Pub. Date: Aug. 13, 2015

(54) MANIFOLD WITH VALVE ASSEMBLY FOR LAWN AND GARDEN SPRAYERS

(71) Applicant: Green Leaf, Inc., Fontanet, IN (US)

(72) Inventor: GREG MANSFIELD, West Terre Haute, IN (US)

(21) Appl. No.: 14/176,689

(22) Filed: Feb. 10, 2014

(51) Int. Cl. A01C 23/00; A01G 25/16; A01G 25/14; B05B 9/04; A01C 23/04

(52) U.S. Cl. CPC A01C 23/007; B05B 9/0403; A01C 23/047; A01G 25/145; A01G 25/16

(57) ABSTRACT

A lawn/garden spraying device comprising a manifold having a gauge outlet path and one or more outlet paths, and a pressure sensing device attached to the gauge outlet path for sensing the fluid pressure within the manifold. The device also comprises a variable valve for regulating the pressure of the lawn/garden liquid within the manifold.

### BACKGROUND

Spraying of lawn/garden liquids, such as pesticides, herbicides, and fertilizers is a well-established technique for dispensing such liquids over large or small target areas. Spraying allows for generally uniform coverage of the dispensed liquid over a target area while limiting waste or run-off. Many lawn and garden spray systems include pressurized fluid flow to dispersal components such as booms or hand held wands for dispensing of lawn/garden liquids.

A disadvantage of prior spray systems is inefficient regulation of the fluid pressure within the system. Over or under pressurized dispersal components (e.g. booms and/or wands) result in waste of lawn/garden liquid as overspray may drift from its intended target, or under application resulting in under utilization of the lawn/garden liquid. Misapplication of lawn/garden liquids can result in lawn or garden damage or damage to animals in the area. Prior spraying devices lacked real time monitoring of internal fluid pressures entering the dispersal components, and means to fine tune the internal fluid pressure so as to minimize waste and maximize efficiency. A need therefore exists for a lawn/garden spraying device in which the internal fluid pressure entering the dispersal components can be efficiently and easy monitored and regulated.

### SUMMARY

In certain aspects the present disclosure provides unique lawn/garden spraying devices and methods for their use, which enable the user to effectively monitor and control the fluid pressure within the device. In accordance with some forms of practicing the disclosure such spraying devices are configured to monitor and allow precise regulation of the spray pressure within the device. Accordingly, in one embodiment, the present disclosure provides a lawn/garden spraying device having a tank adapted for storage of a liquid, an inlet fitting defining an inlet path in fluid communication with the tank, and a manifold having a manifold chamber in fluid communication with the tank through the inlet path. The manifold further comprises a gauge path in fluid communication with the manifold chamber, and one or more outlet paths also in fluid communication with the manifold chamber. A pressure sensing device is included; the pressure sensing device is configured to monitor the fluid pressure within the manifold chamber, through the gauge path. The device further includes a display configured to display the fluid pressure as measured by the pressure sensing the device. The device also includes a variable valve, the variable valve is adapted to regulate the fluid pressure within the manifold chamber. In certain embodiments the device includes a fluid return hose attached to the variable valve and configured to allow fluid transport between the variable valve and the tank. In accordance with certain inventive variants, the variable valve comprises a stem valve. In some forms, the manifold has two dispersal outlet paths. In certain embodiments, each dispersal outlet path includes a shut-off valve configured to seal or allow fluid flow through the path. In one aspect, the dispersal outlet paths are configured for connection to liquid dispersal components, for example, a boom and/or a wand.

In another embodiment, the disclosure provides a manifold for lawn/garden sprayers. The manifold having a manifold chamber having an inlet path, a gauge path, a fluid return path, and one or more dispersal outlet paths adapted for attachment of one or more liquid dispersal components. The manifold further includes a variable valve within said fluid return path adapted to regulate the fluid pressure within the manifold chamber. The manifold also includes a pressure sensing device with a display, the pressure sensing device in fluid communication with the gauge path and adapted to measure and display the fluid pressure within the manifold chamber. In accordance with certain inventive variants, the variable valve comprises a stem valve.

In yet another embodiment the disclosure provides a method for controlling spray pressure of a lawn/garden sprayer. Such method comprises pumping a liquid through an inlet path into a manifold chamber, the manifold chamber in fluid communication with a fluid return path having a variable valve configured to regulate the fluid pressure within the manifold chamber. The manifold chamber is in fluid communication with a pressure sensing device configured to measure the fluid pressure with the manifold chamber, and the manifold chamber also having one or more dispersal outlet paths configured for attachment of one or more liquid dispersal components. The method also includes adjusting the variable valve to obtain a desired pressure within the manifold chamber. In some forms, the method further includes checking the fluid pressure as indicated by a display configured to display the fluid pressure as measured by said pressure sensing device

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a perspective view of one embodiment of the present disclosure.

FIG. 2 is a top down view of one embodiment of the present disclosure.

FIG. 3 is a cutaway view of one embodiment of the present disclosure.

FIG. 4 is a perspective view of one embodiment of the present disclosure.

### DESCRIPTION OF THE SELECTED EMBODIMENTS

For the purpose of promoting an understanding of the principles of the disclosure, reference will now be made to the embodiments illustrated in the drawings and specific language will be used to describe the same. It will nevertheless be understood that no limitation of the scope of the disclosure is thereby intended. Any alterations and further modifications in the described embodiments, and any further applications of the principles of the invention as described herein are contemplated as would normally occur to one skilled in the art to which the invention relates. One embodiment of the disclosed device is shown in great detail; although it will be apparent to those skilled in the relevant art that some features that are not relevant to the present disclosure may not be shown for the sake of clarity.

In certain aspects, the present disclosure provides a unique lawn/garden spraying device, and methods for its use, that enables the user to effectively monitor and control the fluid spray pressure. In accordance with some forms of the invention, such spraying devices are configured to include a manifold chamber in fluid communication with a pressure sensing device and one or more liquid dispersal components, the manifold chamber also having an outlet path having a variable valve. As will be discussed herein, in some forms the variable valve is configured to be manually adjusted and the pressure monitored via a display so as to allow precise regulation of the fluid pressure within the manifold chamber.

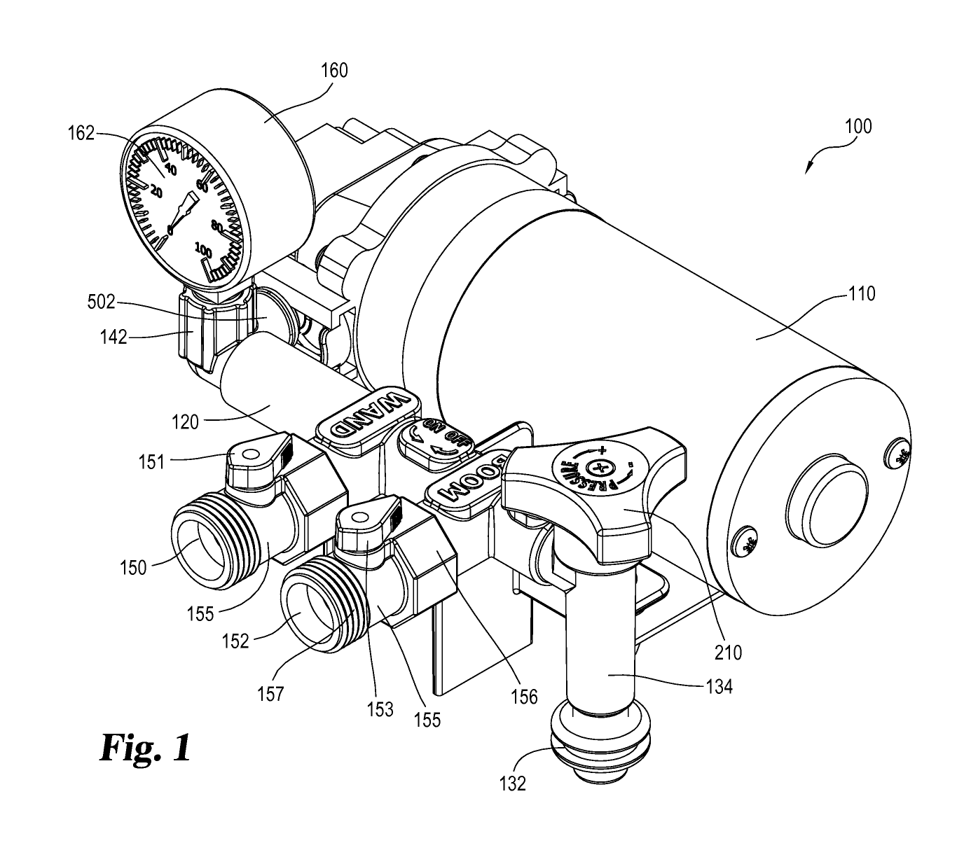

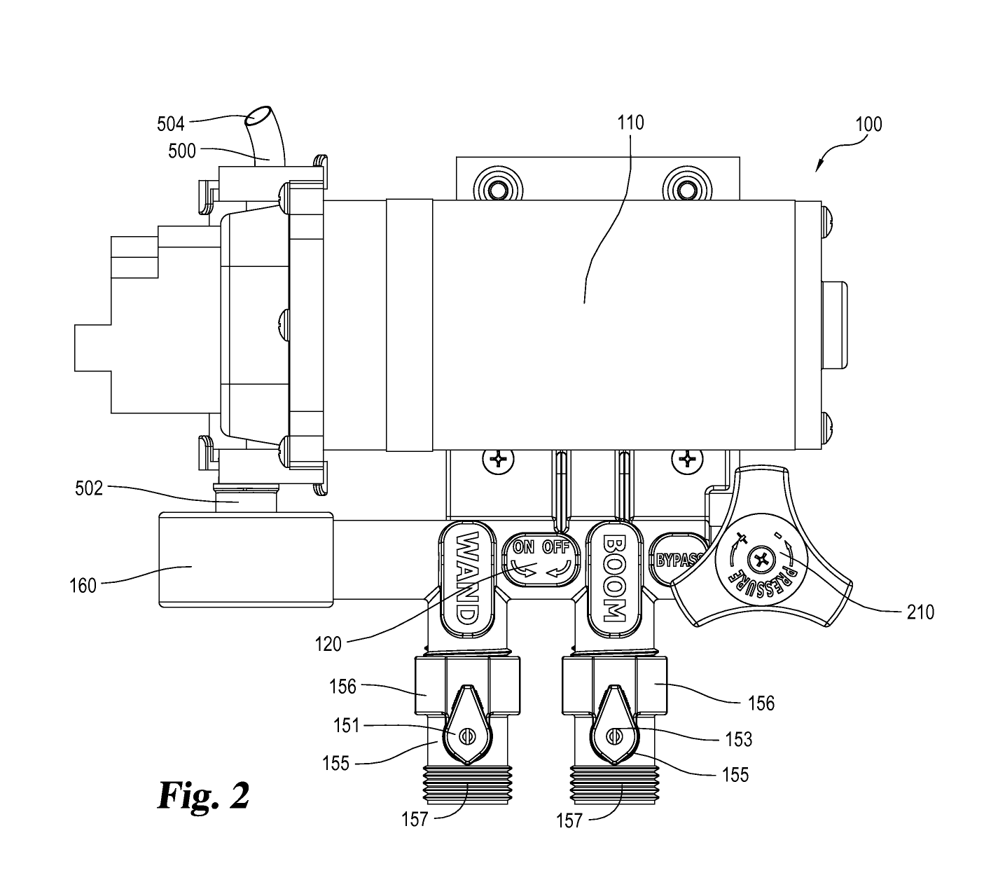

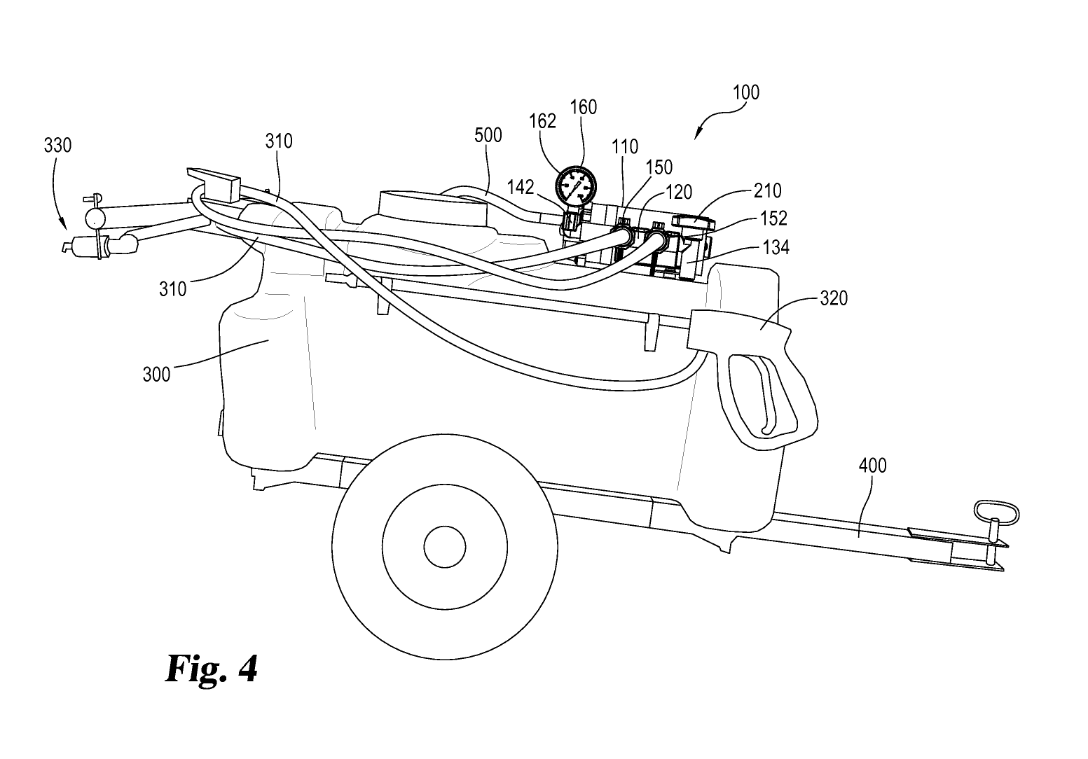

With reference to FIGS. 1 and 2, shown is a perspective view and a top down view of one embodiment of a lawn/garden spraying device of the present disclosure. Device 100 includes manifold 120 having an inlet fitting 502, fluid return fitting 134, gauge fitting 142, and dispersal outlet paths 150 and 152. The illustrated embodiment also includes pressure sensing device 160 attached to gauge fitting 142. In accordance with certain inventive variants, pressure sensing device 160 includes a display 162. In some forms, device 100 includes pump 110. In certain embodiments, fluid return fitting 134 is adapted to attach to a liquid storage tank (300, FIG. 4), for example, fluid return fitting 134 may include adapter 132. In some forms, fluid return fitting 134 is connected to a hose configured to transfer fluid to a storage tank. In accordance with the present disclosure, fluid return fitting 134 includes a variable valve. In some forms, variable valve control 210 allows for manual adjustment of the variable valve. In some forms, dispersal outlet paths 150, 152 further include shut-off valves 151, 153 configured to controllably seal or allow fluid flow through outlet path 150 and/or 152.

In accordance with certain embodiments, inlet fitting 502 defines an inlet path 504 in fluid communication with manifold 122 and tank (300, FIG. 4). In some forms, inlet path 504 is further defined by inlet hose 500. In certain inventive variants, inlet hose 500 may further comprise a filter. Device 100 may be configured such that pump 110 causes fluid to be drawn into inlet path 504 causing fluid pressure to build within manifold 122.

In certain embodiments, one or more dispersal outlet path fittings 155 are attached to manifold 120. In some forms, the dispersal outlet paths are defined by dispersal outlet path fittings 155. In accordance with certain inventive variants, dispersal outlet path fittings include a shut-off valve described herein adapted to seal or allow flow through dispersal outlet paths. In accordance with certain inventive variants, dispersal outlet path fittings 155 are removably attached to or integrated with manifold 120, for example by a threaded fitting 156. It is also envisioned that dispersal outlet path fittings 155 may be permanently attached to manifold 120. In some forms, dispersal outlet fittings 155 are configured for connection to liquid dispersal components (e.g. a boom and/or a hand held wand) for example, each dispersal outlet fitting may include a threaded fitting 157 for attachment to a liquid dispersal component.

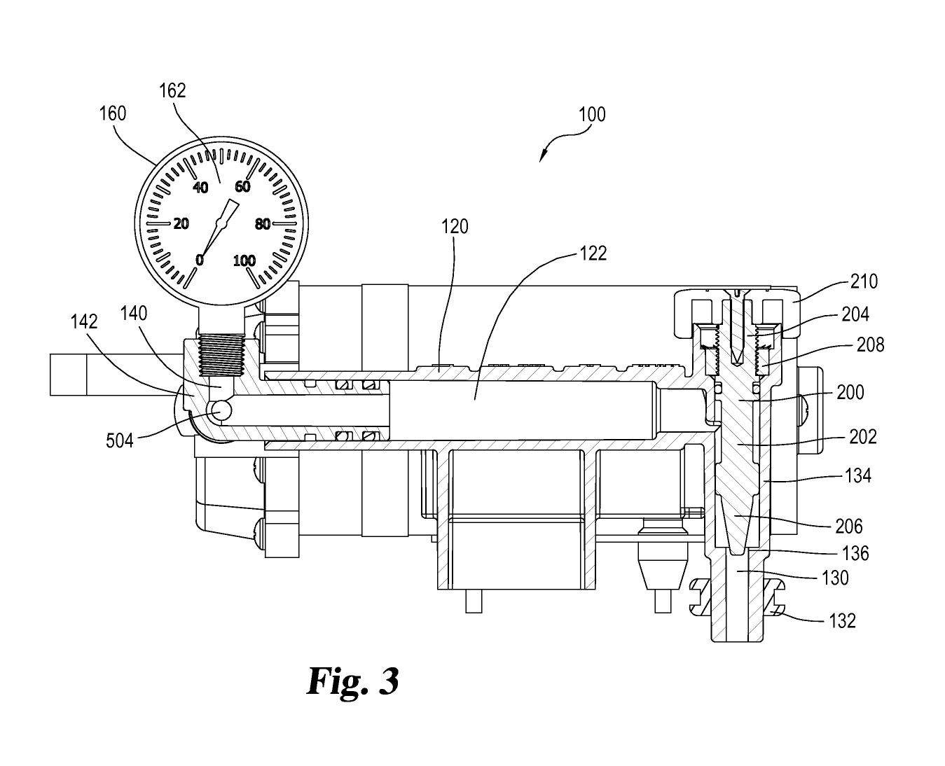

Turning now to FIG. 3, shown is a cutaway view of one embodiment of a lawn/garden spraying device of the present disclosure. Device 100 includes manifold 120 defining manifold chamber 122. In some forms, manifold chamber 122 is in fluid communication with fluid return path 130 defined by fluid return fitting 134, gauge path 140 defined by gauge fitting 142, inlet path 504, and one or more dispersal outlet paths (not shown in FIG. 3). As shown in the illustrated embodiment, fluid return fitting 134 includes variable valve 200.

In use, a pressurized liquid is pumped, or otherwise supplied under pressure, into manifold chamber 122 through inlet path 504. Variable valve 200 allows precise (i.e. increments of less than 2 psi) control of the amount of pressure in manifold chamber 122. The pressure within manifold chamber 122 is measured by pressure sensing device 160, and indicated by display 162. Variable valve 200 allows pressurized liquid to controllably flow through fluid return path 130 thus controlling or reducing the fluid pressure within manifold chamber 122. In some forms, liquid passing through fluid return path 130 is returned to tank (300, FIG. 4). In accordance with certain inventive variants fluid return fitting 134 is attached directly to a storage tank (300, FIG. 4), in alternative embodiments fluid return fitting 134 may communicate with a storage tank via a hose or similar fitting. When open, shut-off valve 151 and/or shut-off valve 153 allow the pressurized liquid to pass through dispersal outlet path 150 and/or 152.

In accordance with certain inventive variants, dispersal outlet path 150 and/or dispersal outlet path 152 are each configured for connection to a liquid dispersal component. In certain preferred forms the liquid dispersal component comprises a boom and/or a wand configured for spraying a pressurized liquid. The illustrated embodiments show two dispersal outlet paths. Such a configuration allows for simultaneous attachment of both a boom and a wand. It should be understood that the disclosure encompasses alternative embodiments with one or more dispersal outlet paths, such as those with one dispersal outlet path, as well as those with three or more dispersal outlet paths.

In some forms, each dispersal outlet path includes a shut-off valve configured to alternatively seal or allow fluid passage through each individual dispersal outlet path. In this way, a dispersal outlet path may be selectively sealed so as to allow attachment or detachment of a dispersal component while the manifold chamber is pressurized. Such a configuration also allows for selective pressurization of attached components in accordance with the desired use by an operator. Shut-off valves for use in the present disclosure are typically configured to allow gross adjustment of the fluid flow through each individual dispersal outlet path. In certain preferred embodiments, the shut-off valves are ball valves.

Pressure sensing device 160 may be connected directly to manifold 120, connected by way of a gauge fitting 142, or any other suitable arrangement which allows constant measurement of the fluid pressure within manifold chamber 122. In so doing, pressure sensing device 160 measures the spray pressure supplied to the attached liquid dispersal components. In some forms, pressure sensing device 160 is removably attached to manifold 120, for example by a threaded coupling. In other forms, pressure sensing device is permanently attached to or integrated with manifold 120. In some forms, display 162 comprises an analog needle display; in other forms display 162 is a digital display.

In the illustrated embodiments, variable valve 200 is a stem valve. In certain embodiments, variable valve 200 comprises a stem body 202, having a conical plug portion 206, and threaded portion 204, which fit inside fluid return fitting 134. Fluid return fitting 134 is further adapted so that when stem body 202 is advanced conical plug portion 206 contacts fluid return fitting 134, for example at shoulder 136, a sufficient amount to prevent the transfer of liquid into storage tank (300, FIG. 4), elevation of stem body 202 creates an opening or gap allowing for the transfer of liquid into storage tank (300, FIG. 4) thus relieving fluid pressure within manifold chamber 122. The level of pressure within manifold chamber 122 can be precisely controlled in accordance with the extent to which stem body 202 is elevated. For example, stem body 202 can be advanced to reduce the size of the opening, or retracted to enlarge the opening controllably allowing fluid flow and thus precisely regulating fluid pressure within the manifold. In some forms, a threaded portion 204 of stem body 202 engages a threaded portion of fluid return fitting 134. In certain preferred forms, a hex jam nut is secured within fluid return fitting 134 to provide a threaded portion. In accordance with certain inventive variants, stem body 202 may be rotated causing threaded portion 204 to engage threaded portion of fluid return fitting 134 such that stem body 202 is advanced or elevated. In some forms, rotation of stem body 202 is achieved by manual rotation of a variable valve control 210, such as a handle or knob, which is coupled to stem body. In certain embodiments the variable valve is configured so as to allow for precise control over the fluid pressure within the manifold chamber. For example, in some forms the internal fluid pressure may be adjusted in increments as small as 1-2 psi, in certain preferred embodiments the internal fluid pressure may be adjusted in 1 psi increments. Alternate high precision adjustment valves may alternatively be used.

With reference to FIG. 4, the device of the present disclosure is configured for use with a lawn/garden liquid. In some forms the liquid is stored in a tank 300. In certain embodiments, a pump and/or motor 110 draws liquid from the tank and then supplies it to manifold chamber 122. In some forms, the device is configured for use with an electric pump, for example a 12-volt electric pump. In many embodiments the device includes, or is configured for use with, a fixed displacement pump. In alternative embodiments the device includes, or is configured for use with a variable displacement pump. Especially with respect to embodiments including a fixed displacement pump, variable valve 200 operates as a pressure release valve or bleed-off valve, allowing a user to balance or control a known constant in-flow against a known output through fluid return path and dispersal outlet path(s), thus allowing control of the fluid pressure within manifold 120.

In some forms, the device, for example the pump, is connected to an electric power supply on a separate lawn/garden device (e.g a lawn tractor, or ATV). In accordance with certain inventive variants, the device of the present disclosure is adapted to be mounted on a trailer 400. Alternately the device is adapted to be mounted onto a portion of a vehicle, such as a rear deck of a lawn tractor or ATV. In certain embodiments, tubing 310 is connected to outlet path 150 and/or outlet path 152 such that manifold chamber 122 is in fluid communication with a liquid dispersal component attached at the distal end of tubing 310. As illustrated in FIG. 4, liquid dispersal components for use with the disclosed device include but are not limited to a hand-held wand 320, or a boom 330 configured to spray a lawn/garden liquid. Lawn/garden liquids for use with the disclosed device and methods include, but are not limited to: water, pesticides, herbicides, fertilizers, and growth regulators.

In certain alternate embodiments the device of the present disclosure may be adapted to be carried by a user, for example in a backpack or pull-cart. In some forms, the device includes a manual pump which can be periodically pumped so as to pressurize the liquid within the device. Certain inventive methods include periodically manually pumping the device so as to maintain a desired pressure as indicated by the display.

The present disclosure also includes methods for controlling spray pressure of a lawn/garden sprayer. In some forms, such methods include pumping a liquid into a device as disclosed herein and adjusting the pressure regulating valve so as to obtain a desired pressure within the manifold chamber. The disclosed method may include monitoring the fluid pressure within the manifold chamber of a device as disclosed herein. Such methods may also include dispensing the pressurized liquids through a dispersal component such as a boom and/or a wand.

While the disclosed device has been illustrated and described in detail in the drawings and foregoing description, the same is to be considered as illustrative and not restrictive in character, it being understood that only the preferred embodiment has been shown and described and that all changes, equivalents, and modifications that come within the spirit of the disclosure defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A lawn/garden spraying device comprising:
a tank adapted for storage of a liquid;
an inlet fitting defining an inlet path in fluid communication with said tank;
a manifold having a manifold chamber, said manifold chamber in fluid communication with said tank through said inlet path, wherein said manifold further comprises a gauge path in fluid communication with said manifold chamber and one or more dispersal outlet paths in fluid communication with said manifold chamber;
a pressure sensing device, said pressure sensing device in fluid communication with said gauge path and adapted to measure the fluid pressure within said manifold chamber;
a display configured to display the fluid pressure as measured by said pressure sensing device; and
a variable valve adapted to regulate the fluid pressure within said manifold chamber, and wherein said variable valve is configured so as to allow adjustments of the fluid pressure within said manifold chamber of less than 2 psi increments.

2. The lawn/garden spraying device of claim 1, wherein said variable valve comprises a stem valve.

3. The lawn/garden spraying device of claim 1, comprising two dispersal outlet paths.

4. The lawn/garden spraying device of claim 1, wherein said one or more dispersal outlet paths include one or more shut-off valves.

5. The lawn/garden spraying device of claim 1, comprising a fluid return hose attached to said variable valve and configured to allow fluid transport between said variable valve and said tank.

6. The lawn/garden spraying device of claim 1 wherein, said one or more dispersal outlet paths are configured for connection to one or more liquid dispersal components.

7. The lawn/garden spraying device of claim 6 wherein, said liquid dispersal component comprises a boom.

8. The lawn/garden spraying device of claim 6 wherein, said liquid dispersal component comprises a hand held wand.

9. The lawn/garden spraying device of claim 1 comprising a pump configured to transfer liquid into said manifold chamber.

10. The lawn/garden spraying device of claim 9, wherein said pump comprises a fixed displacement pump.

11. The lawn/garden spraying device of claim 2 wherein said stem valve is manually adjustable.

12. A manifold for lawn/garden sprayers, said manifold comprising:
a manifold chamber having an inlet path, a gauge path, a fluid return path, and one or more dispersal outlet paths, wherein said fluid return path includes a variable valve adapted to regulate the fluid pressure within said manifold chamber;
a pressure sensing device having a display, said pressure sensing device in fluid communication with said gauge path and adapted to measure and display the fluid pressure within said manifold chamber; and
wherein said one or more dispersal outlet paths are adapted for attachment of one or more liquid dispersal components.

13. The manifold of claim 12 wherein, said variable valve comprises a stem valve.

14. The manifold of claim 12 comprising two dispersal outlet paths.

15. The manifold of claim 12 wherein said dispersal outlet paths each include a shut-off valve.

16. The manifold of claim 15 wherein said shut-off valve is a ball valve.

17. The manifold of claim 12 wherein, said liquid dispersal component is a boom.

18. The manifold of claim 12 wherein, said liquid dispersal component is a hand held wand.

19. A method for controlling spray pressure of a lawn/garden sprayer, said method comprising:
pumping a liquid through an inlet path into a manifold chamber, said manifold chamber in fluid communication with a fluid return path, the fluid return path having a variable valve configured to precisely regulate the fluid pressure within the manifold chamber with increments less than 2 psi, the manifold chamber in fluid communication with a pressure sensing device configured to measure the fluid pressure within the manifold chamber, the manifold chamber also having one or more dispersal outlet paths, wherein each dispersal outlet path is configured for attachment of a liquid dispersal component; and
adjusting the variable valve to obtain a desired pressure within the manifold chamber.

20. The method of claim 19 comprising, checking the fluid pressure as indicated by a display configured to display the fluid pressure within the manifold as measured by the pressure sensing device
